(19) United States
(12) Patent Application Publication
(10) Pub. No.: US 2017/0270524 A1
(43) Pub. Date: Sep. 21, 2017

(54) ELECTRONIC DEVICE FOR PERFORMING SECURE PAYMENT AND METHOD THEREOF

(71) Applicant: Samsung Electronics Co., Ltd., Suwon-si (KR)

(72) Inventor: Kyung Dong KIM, Suwon-si (KR)

(21) Appl. No.: 15/461,943

(22) Filed: Mar. 17, 2017

(30) Foreign Application Priority Data
Mar. 21, 2016 (KR) 10-2016-0033562

(51) Int. Cl. G06Q 20/40; G06Q 20/34

(52) U.S. Cl. CPC G06Q 20/405; G06Q 20/348; G06Q 20/401

(57) ABSTRACT

An electronic device is provided. The electronic device includes a user input circuit configured to allow a user of the electronic device to select a payment means, a communication circuit configured to receive first security information from the outside and transmit a payment request comprising the first security information and second security information to the outside, and a security information generator configured to generate the second security information.

### CROSS-REFERENCE TO RELATED APPLICATION(S)

This application claims the benefit under 35 U.S.C. §119(a) of a Korean patent application filed on Mar. 21, 2016 in the Korean Intellectual Property Office and assigned Serial number 10-2016-0033562, the entire disclosure of which is hereby incorporated by reference.

### TECHNICAL FIELD

The present disclosure relates to an electronic device for performing a secure payment and a method thereof. More particularly, the present disclosure relates to an electronic device for using security information generated by the electronic device and security information received from the outside for security.

### BACKGROUND

With the development of information communication technologies, base stations have been established in all parts of the country. Electronic devices transmit and receive data with other electronic devices over networks, thus allowing users to use networks everywhere in the country.

Recently, various types of electronic devices have provided a variety of functions based on a trend towards digital convergence. For example, smartphones support an Internet access function using the networks and support a function of reproducing music or videos and a function of capturing photos, videos using cameras, and the like, other than a voice call function.

Further, the various types of electronic devices comprise an antenna for payment and store card information, thus allowing users to perform payment transactions.

In payment using smartphones, in case of online payment, there may be security problems, such as taking approval numbers transmitted from a card issuer server. In case of offline payment, problems may occur due to the cracking of an algorithm of generating security information, such as a one-time password (OTP).

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device for using security information generated by the electronic device and security information received from the outside for security.

In accordance with an aspect of the present disclosure, an electronic device is provided. The electronic device includes a communication interface, a memory, and a processor. The processor may be configured to activate an application for a payment transaction based on an input on the electronic device, receive first authentication information corresponding to a payment means associated with the payment transaction from an external electronic device via the communication interface, generate second authentication information associated with the payment means using identification information stored in the memory, based on receiving the first authentication information, transmit payment information comprising at least part of the first authentication information and the second authentication information to the external electronic device via the communication interface, receive a result of authenticating the transmitted payment information from the external electronic device via the communication interface, and perform the payment transaction based on the authenticated result.

In accordance with another aspect of the present disclosure, an electronic device is provided. The electronic device includes a communication interface, a memory, and a processor. The processor may be configured to activate an application for a payment transaction based on an input on the electronic device, receive first authentication information corresponding to a payment means associated with the payment transaction and second authentication information associated with the payment means from an external electronic device via the communication interface, the second authentication information being generated using identification information stored in the memory, transmit payment information comprising at least part of the first authentication information and the second authentication information to the external electronic device via the communication interface, receive a result of authenticating the transmitted payment information from the external electronic device via the communication interface, and perform the payment transaction based on the authenticated result.

In accordance with another aspect of the present disclosure, an electronic device is provided. The electronic device includes a user input circuit configured to allow a user of the electronic device to select a payment means, a communication circuit configured to receive first security information from the outside and transmit a payment request comprising the first security information and second security information to the outside, and a security information generator configured to generate the second security information.

In accordance with another aspect of the present disclosure, a method performed in an electronic device is provided. The method includes allowing a user of the electronic device to select a payment means, receiving first security information from the outside, generating second security information, and transmitting a payment request comprising the first security information and the second security information to an external device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device in a network environment according to an embodiment of the present disclosure;

FIG. 2 is a block diagram illustrating a configuration of an electronic device according to an embodiment of the present disclosure;

FIG. 3 is a block diagram illustrating a configuration of a program module according to an embodiment of the present disclosure;

FIG. 4 is a drawing illustrating an environment of performing a secure payment service according to an embodiment of the present disclosure;

FIG. 5 is a block diagram illustrating a configuration of an electronic device for performing a secure payment service according to an embodiment of the present disclosure;

FIG. 6 is a drawing illustrating an information structure according to an embodiment of the present disclosure;

FIG. 7 is a signal sequence diagram illustrating a method for registering a payment means according to an embodiment of the present disclosure;

FIG. 8 is a signal sequence diagram illustrating a method for performing payment according to an embodiment of the present disclosure;

FIG. 9 is a flowchart illustrating a method for performing payment in an electronic device according to an embodiment of the present disclosure; and

FIG. 10 is a flowchart illustrating a method for performing payment in an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure disclosed herein, the expressions “have”, “may have”, “include” and “comprise”, or “may include” and “may comprise” used herein indicate existence of corresponding features (e.g., elements, such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The expressions, such as “1st”, “2nd”, “first”, or “second”, and the like used in various embodiments of the present disclosure may refer to various elements irrespective of the order and/or priority of the corresponding elements, but do not limit the corresponding elements. The expressions may be used to distinguish one element from another element. For instance, both “a first user device” and “a second user device” indicate different user devices from each other irrespective of the order and/or priority of the corresponding elements. For example, a first component may be referred to as a second component and vice versa without departing from the scope of the present disclosure.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

Depending on the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to perform A, B, and C” may mean a generic-purpose processor (e.g., a central processing unit (CPU) or an application processor) which may perform corresponding operations by executing one or more software programs which stores a dedicated processor (e.g., an embedded processor) for performing a corresponding operation.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

Electronic devices according to various embodiments of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), a moving picture experts group (MPEG-1 or MPEG-2) Audio Layer 3 (MP3) players, mobile medical devices, cameras, or wearable devices. According to various embodiments of the present disclosure, the wearable devices may include at least one of accessory-type wearable devices (e.g., watches, rings, bracelets, anklets, necklaces, glasses, contact lenses, or head-mounted-devices (HMDs)), fabric or clothing integral wearable devices (e.g., electronic clothes), body-mounted wearable devices (e.g., skin pads or tattoos), or implantable wearable devices (e.g., implantable circuits).

In various embodiments of the present disclosure, the electronic devices may be smart home appliances. The smart home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ and PlayStation™), electronic dictionaries, electronic keys, camcorders, or electronic picture frames.

In various embodiments of the present disclosure, the electronic devices may include at least one of various medical devices (e.g., various portable medical measurement devices (e.g., blood glucose meters, heart rate meters, blood pressure meters, or thermometers, and the like), a magnetic resonance angiography (MRA), a magnetic resonance imaging (MRI), a computed tomography (CT), scanners, or ultrasonic devices, and the like), navigation devices, global navigation satellite system (GNSS), event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to various embodiments of the present disclosure, the electronic devices may include at least one of parts of furniture or buildings/structures, electronic boards, electronic signature receiving devices, projectors, or various measuring instruments (e.g., water meters, electricity meters, gas meters, or wave meters, and the like). The electronic devices according to various embodiments of the present disclosure may be one or more combinations of the above-mentioned devices. The electronic devices according to various embodiments of the present disclosure may be flexible electronic devices. That is, electronic devices according to various embodiments of the present disclosure are not limited to the above-mentioned devices, and may include new electronic devices according to technology development.

Hereinafter, electronic devices according to various embodiments will be described with reference to the accompanying drawings. The term “user” used herein may refer to a person who uses an electronic device or may refer to a device (e.g., an artificial electronic device) that uses an electronic device.

Herein, a description will be given of an example in which an electronic device according to various embodiments of the present disclosure is a smartphone, with reference to the accompanying drawings.

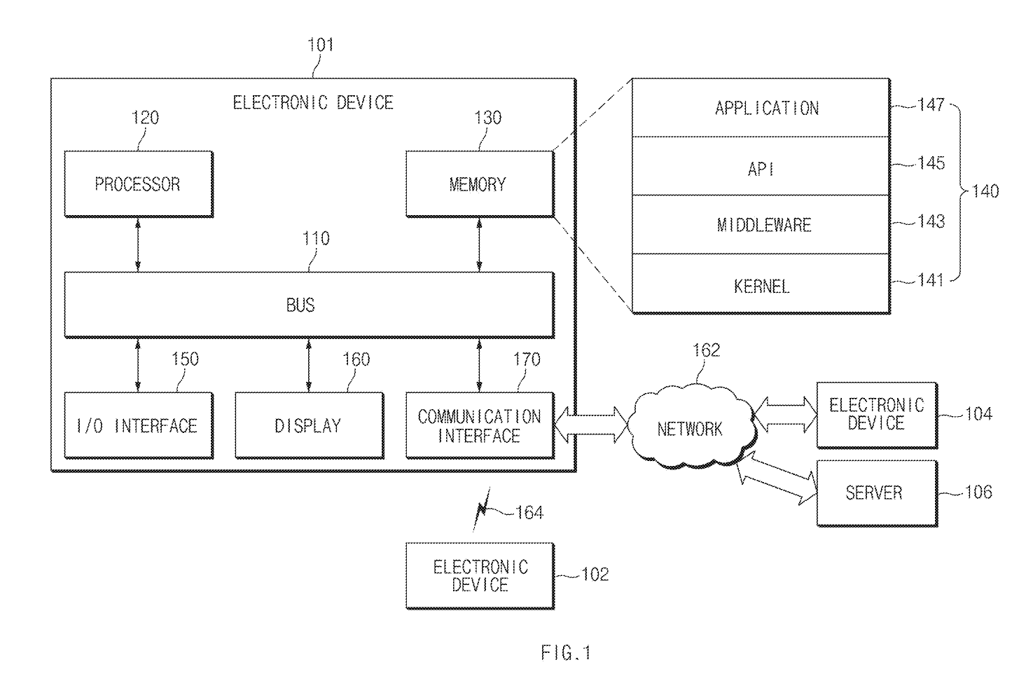

FIG. 1 is a block diagram illustrating a configuration of an electronic device in a network environment according to an embodiment of the present disclosure.

Referring to FIG. 1, in various embodiments of the present disclosure, an electronic device 101 may connect with a first external electronic device 102 over local-area communication 164 or may connect with a second external electronic device 104 or a server 106 over a network 162. The electronic device 101 may include a bus 110, a processor 120, a memory 130, an input/output (I/O) interface 150, a display 160, and a communication interface 170. In various embodiments of the present disclosure, at least one of the components of the electronic device 101 may be omitted from the electronic device 101, and other components may be additionally included in the electronic device 101.

The bus 110 may include, for example, a circuit which connects the components 120 to 170 with each other and sends communication (e.g., a control message and/or data) between the components 120 to 170.

The processor 120 may include one or more of a central processing unit (CPU), an application processor (AP), or a communication processor (CP). The processor 120 may perform, for example, calculation or data processing about control and/or communication of at least another of the components of the electronic device 101.

The memory 130 may include a volatile and/or non-volatile memory. The memory 130 may store, for example, a command or data associated with at least another of the components of the electronic device 101. According to an embodiment of the present disclosure, the memory 130 may software and/or a program 140. The program 140 may include, for example, a kernel 141, a middleware 143, an application programming interface (API) 145, and/or at least one application program 147 (or “at least one application”), and the like. At least part of the kernel 141, the middleware 143, or the API 145 may be referred to as an operating system (OS).

The kernel 141 may control or manage, for example, system resources (e.g., the bus 110, the processor 120, or the memory 130, and the like) used to execute an operation or function implemented in the other programs (e.g., the middleware 143, the API 145, or the application program 147). That is, as the middleware 143, the API 145, or the application program 147 accesses a separate component of the electronic device 101, the kernel 141 may provide an interface which may control or manage system resources.

The middleware 143 may play a role as, for example, a go-between such that the API 145 or the application program 147 communicates with the kernel 141 to communicate data with the kernel 141.

That is, the middleware 143 may process one or more work requests, received from the at least one application program 147, in order of priority. For example, the middleware 143 may assign priority which may use system resources (the bus 110, the processor 120, or the memory 130, and the like) of the electronic device 101 to at least one of the at least one application program 147. For example, the middleware 143 may perform scheduling or load balancing for the one or more work requests by processing the one or more work requests in order of priority assigned to the at least one of the at least one application program 147.

The API 145 may be, for example, an interface in which the application program 147 controls a function provided from the kernel 141 or the middleware 143. For example, the API 145 may include at least one interface or function (e.g., a command) for file control, window control, image processing, or text control, and the like.

The I/O interface 150 may play a role as, for example, an interface which may send a command or data, input from a user or another external device, to another component (or other components) of the electronic device 101. That is, the I/O interface 150 may output a command or data, received from another component (or other components) of the electronic device 101, to the user or the other external device.

The display 160 may include, for example, a liquid crystal display (LCD), a light emitting diode (LED) display, an organic LED (OLED) display, a microelectromechanical systems (MEMS) display, or an electronic paper display. The display 160 may display, for example, a variety of content (e.g., text, an image, a video, an icon, or a symbol, and the like) to the user. The display 160 may include a touch screen, and may receive, for example, a touch, a gesture, proximity, or a hovering input using an electronic pen or part of a body of the user.

The communication interface 170 may establish communication between, for example, the electronic device 101 and an external device (e.g., the first external electronic device 102, the second external electronic device 104, or the server 106). For example, the communication interface 170 may connect to the network 162 through wireless communication or wired communication and may communicate with the external device (e.g., the second external electronic device 104 or the server 106).

The wireless communication may include, for example, cellular communication which uses at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM) as a cellular communication protocol. According to an embodiment of the present disclosure, the wireless communication may include, for example, at least one of Wi-Fi communication, Bluetooth (BT) communication, Bluetooth low energy (BLE) transmission, Zigbee communication, near field communication (NFC) communication, magnetic secure transmission (MST) communication, radio frequency (RF) communication, or a body area network (BAN) communication. According to an embodiment of the present disclosure, the wireless communication may include a global navigation satellite system (GNSS). The GNSS may be, for example, a global positioning system (GPS), a global navigation satellite system (Glonass), a Beidou navigation satellite system (hereinafter referred to as “Beidou”), or a Galileo (i.e., the European global satellite-based navigation system). Hereinafter, the “GPS” used herein may be interchangeably used with the “GNSS”.

An MST module may generate a pulse based on transmission data using an electromagnetic signal and may generate a magnetic field signal based on the pulse. The electronic device 101 may send the magnetic field signal to a POS system. The POS system may restore the data by detecting the magnetic field signal using an MST reader and converting the detected magnetic field signal into an electric signal.

The GNSS may include, for example, at least one of a GPS, a global navigation satellite system (Glonass), a Beidou navigation satellite system (hereinafter referred to as “Beidou”), or a Galileo (i.e., the European global satellite-based navigation system) according to an available area or a bandwidth, and the like. Hereinafter, the “GPS” used herein may be interchangeably used with the “GNSS”. The wired communication may include at least one of, for example, universal serial bus (USB) communication, high definition multimedia interface (HDMI) communication, recommended standard 232 (RS-232) communication, or plain old telephone service (POTS) communication, and the like. The network 162 may include a telecommunications network, for example, at least one of a computer network (e.g., a local area network (LAN) or a wide area network (WAN)), the Internet, or a telephone network.

Each of the first and second external electronic devices 102 and 104 may be the same as or different device from the electronic device 101. According to an embodiment of the present disclosure, the server 106 may include a group of one or more servers. According to various embodiments of the present disclosure, all or some of operations executed in the electronic device 101 may be executed in another electronic device or a plurality of electronic devices (e.g., the first external electronic device 102, the second external electronic device 104, or the server 106). According to an embodiment of the present disclosure, if the electronic device 101 will perform any function or service automatically or according to a request, it may request another device (e.g., the first external electronic device 1102, the second external electronic device 104, or the server 106) to perform at least part of the function or service, rather than executing the function or service for itself or in addition to the function or service. The other electronic device (e.g., the first external electronic device 102, the second external electronic device 104, or the server 106) may execute the requested function or the added function and may transmit the executed result to the electronic device 101. The electronic device 101 may process the received result without change or additionally and may provide the requested function or service. For this purpose, for example, cloud computing technologies, distributed computing technologies, or client-server computing technologies may be used.

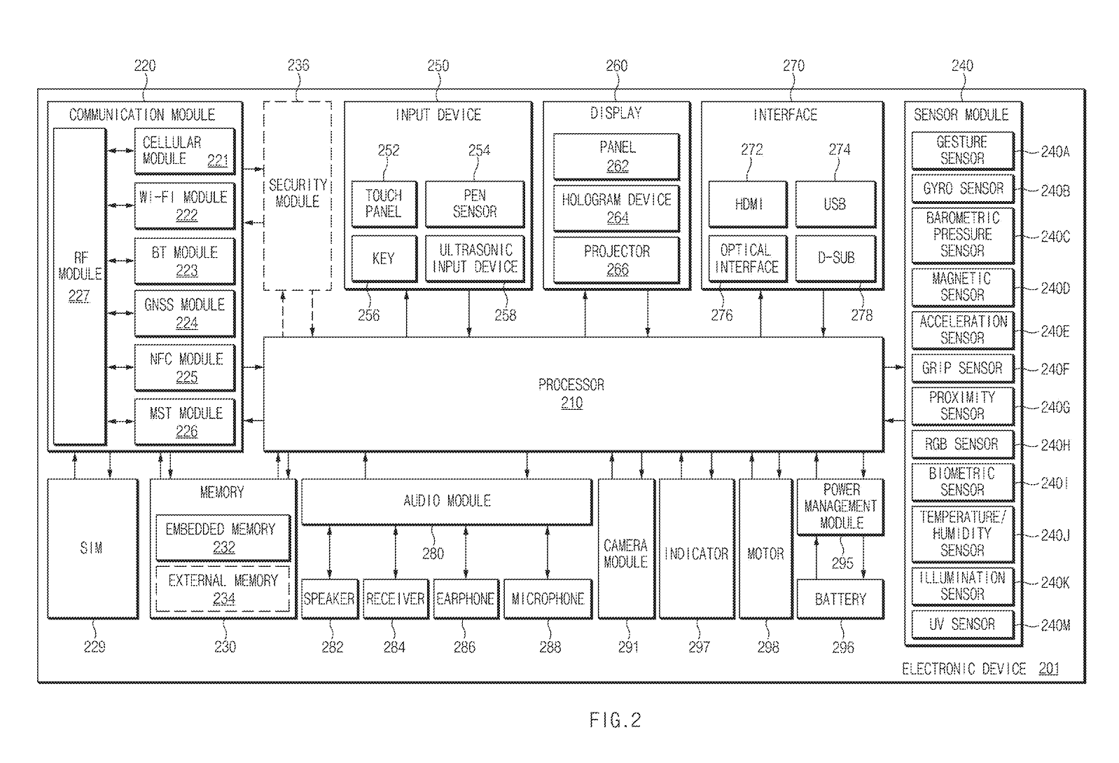

FIG. 2 is a block diagram illustrating a configuration of an electronic device according to an embodiment of the present disclosure.

Referring to FIG. 2, an electronic device 201 may include, for example, all or part of an electronic device 101 shown in FIG. 1. The electronic device 201 may include one or more processors 210 (e.g., APs), a communication module 220, a subscriber identification module (SIM) 229, a memory 230, a sensor module 240, an input device 250, a display 260, an interface 270, an audio module 280, a camera module 291, a power management module 295, a battery 296, an indicator 297, and a motor 298.

The processor 210 may execute, for example, an OS or an application program to control a plurality of hardware or software components connected thereto and may process and compute a variety of data. The processor 210 may be implemented with, for example, a system on chip (SoC). According to an embodiment of the present disclosure, the processor 210 may include a graphic processing unit (GPU) (not shown) and/or an image signal processor (not shown). The processor 210 may include at least some (e.g., a cellular module 221) of the components shown in FIG. 2. The processor 210 may load a command or data, received from at least one of other components (e.g., a non-volatile memory), to a volatile memory to process the data and may store various data in a non-volatile memory.

The communication module 220 may have the same or similar configuration to a communication interface 170 of FIG. 1. The communication module 220 may include, for example, the cellular module 221, a Wi-Fi module 222, a BT module 223, a GNSS module 224 (e.g., a GPS module, a Glonass module, a Beidou module, or a Galileo module), a NFC module 225, an MST module 226, and a RF module 227.

The cellular module 221 may provide, for example, a voice call service, a video call service, a text message service, or an Internet service, and the like over a communication network. According to an embodiment of the present disclosure, the cellular module 221 may identify and authenticate the electronic device 201 in a communication network using the SIM 229 (e.g., a SIM card). According to an embodiment of the present disclosure, the cellular module 221 may perform at least some of functions which may be provided by the processor 210. According to an embodiment of the present disclosure, the cellular module 221 may include a CP.

The Wi-Fi module 222, the BT module 223, the GNSS module 224, the NFC module 225, or the MST module 226 may include, for example, a processor for processing data communicated through the corresponding module. According to various embodiments of the present disclosure, at least some (e.g., two or more) of the cellular module 221, the Wi-Fi module 222, the BT module 223, the GNSS module 224, the NFC module 225, or the MST module 226 may be included in one integrated chip (IC) or one IC package.

The RF module 227 may communicate, for example, a communication signal (e.g., an RF signal). Though not shown, the RF module 227 may include, for example, a transceiver, a power amplifier module (PAM), a frequency filter, or a low noise amplifier (LNA), or an antenna, and the like. According to another embodiment of the present disclosure, at least one of the cellular module 221, the Wi-Fi module 222, the BT module 223, the GNSS module 224, the NFC module 225, or the MST module 226 may communicate an RF signal through a separate RF module.

The SIM 229 may include, for example, a card which includes a SIM and/or an embedded SIM. The SIM 229 may include unique identification information (e.g., an integrated circuit card identifier (ICCID)) or subscriber information (e.g., an international mobile subscriber identity (IMSI)).

The memory 230 (e.g., a memory 130 of FIG. 1) may include, for example, an embedded memory 232 or an external memory 234. The embedded memory 232 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 234 may include a flash drive, for example, a compact flash (CF), a secure digital (SD), a micro-SD, a mini-SD, an extreme digital (xD), a multimedia card (MMC), or a memory stick, and the like. The external memory 234 may operatively and/or physically connect with the electronic device 201 through various interfaces.

The security module 236 may be a module which has a relatively higher secure level than the memory 230 and may be a circuit which stores secure data and guarantees a protected execution environment. The security module 236 may be implemented with a separate circuit and may include a separate processor. The security module 236 may include, for example, an embedded secure element (eSE) which is present in a removable smart chip or a removable SD card or is embedded in a fixed chip of the electronic device 201. That is, the security module 236 may be driven by an OS different from the OS of the electronic device 201. For example, the security module 236 may operate based on a java card open platform (JCOP) OS.

The sensor module 240 may measure, for example, a physical quantity or may detect an operation state of the electronic device 201, and may convert the measured or detected information to an electric signal. The sensor module 240 may include at least one of, for example, a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (e.g., red, green, blue (RGB) sensor), a biometric sensor 240I, a temperature/humidity sensor 240J, an illumination sensor 240K, or an ultraviolet (UV) sensor 240M. Additionally or alternatively, the sensor module 240 may further include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor module 240 may further include a control circuit for controlling at least one or more sensors included therein. In various embodiments of the present disclosure, the electronic device 201 may further include a processor configured to control the sensor module 240, as part of the processor 210 or to be independent of the processor 210. While the processor 210 is in a sleep state, the electronic device 201 may control the sensor module 240.

The input device 250 may include, for example, a touch panel 252, a (digital) pen sensor 254, a key 256, or an ultrasonic input unit 258. The touch panel 252 may use, for example, at least one of a capacitive type, a resistive type, an infrared type, or an ultrasonic type. That is, the touch panel 252 may include a control circuit. The touch panel 252 may further include a tactile layer and may provide a tactile reaction to a user.

The (digital) pen sensor 254 may be, for example, part of the touch panel 252 or may include a separate sheet for recognition. The key 256 may include, for example, a physical button, an optical key, or a keypad. The ultrasonic input unit 258 may allow the electronic device 201 to detect an ultrasonic wave generated by an input tool, through a microphone (e.g., a microphone 288) and to verify data corresponding to the detected ultrasonic wave.

The display 260 (e.g., a display 160 of FIG. 1) may include a panel 262, a hologram device 264, or a projector 266. The panel 262 may include the same or similar configuration to the display 160. The panel 262 may be implemented to be, for example, flexible, transparent, or wearable. The panel 262 and the touch panel 252 may be integrated into one module. According to an embodiment of the present disclosure, the panel 262 may include a pressure sensor (or a force sensor interchangeably used hereafter) which may measure intensity of pressure on a touch of a user. The hologram device 264 may show a stereoscopic image in a space using interference of light. The projector 266 may project light onto a screen to display an image. The screen may be positioned, for example, inside or outside the electronic device 201. According to an embodiment of the present disclosure, the display 260 may further include a control circuit for controlling the panel 262, the hologram device 264, or the projector 266.

The interface 270 may include, for example, an HDMI 272, a USB 274, an optical interface 276, or a D-subminiature 278. The interface 270 may be included in, for example, a communication interface 170 shown in FIG. 1. Additionally or alternatively, the interface 270 may include, for example, a mobile high definition link (MHL) interface, an SD/MMC card interface, or an infrared data association (IrDA) standard interface.

The audio module 280 may interchangeably convert a sound into an electric signal. At least some of components of the audio module 280 may be included in, for example, an input and output interface 150 shown in FIG. 1. The audio module 280 may process sound information input or output through, for example, a speaker 282, a receiver 284, an earphone 286, or the microphone 288, and the like.

The camera module 291 may be a device which captures a still image and a moving image. According to an embodiment of the present disclosure, the camera module 291 may include one or more image sensors (not shown) (e.g., a front sensor or a rear sensor), a lens (not shown), an image signal processor (ISP) (not shown), or a flash (not shown) (e.g., an LED or a xenon lamp).

The power management module 295 may manage, for example, power of the electronic device 201. According to an embodiment of the present disclosure, though not shown, the power management module 295 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 296 and voltage, current, or temperature thereof while the battery 296 is charged. The battery 296 may include, for example, a rechargeable battery or a solar battery.

The indicator 297 may display a specific state of the electronic device 201 or part (e.g., the processor 210) thereof, for example, a booting state, a message state, or a charging state, and the like. The motor 298 may convert an electric signal into mechanical vibration and may generate vibration or a haptic effect, and the like. Though not shown, the electronic device 201 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a mediaFlo™ standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. That is, some of the elements of the electronic device according to various embodiments of the present disclosure may be combined with each other to form one entity, thereby making it possible to perform the functions of the corresponding elements in the same manner as before the combination.

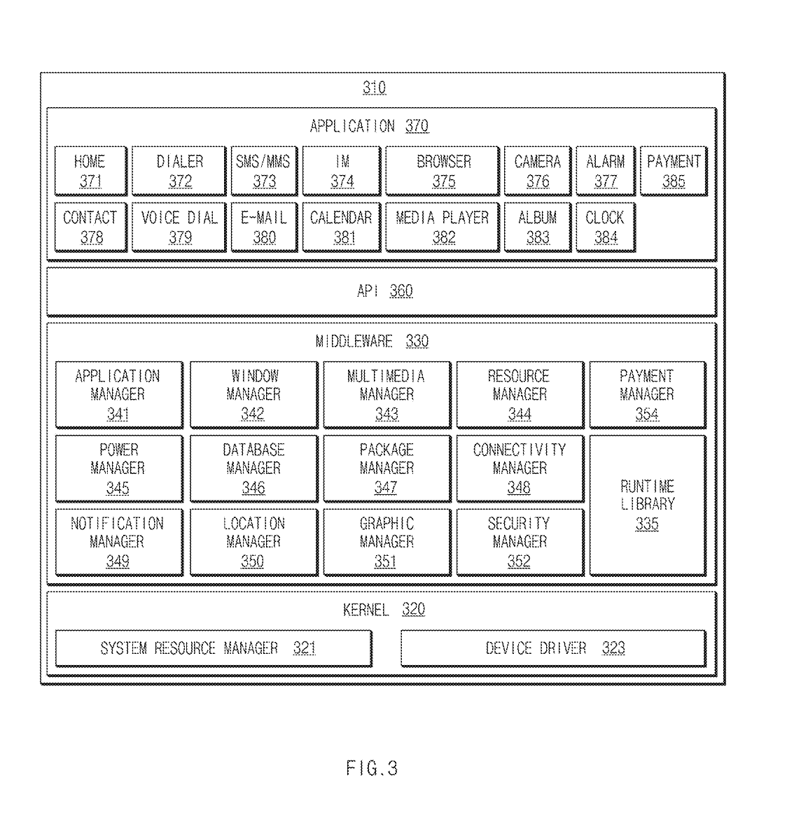

FIG. 3 is a block diagram illustrating a configuration of a program module according to an embodiment of the present disclosure.

Referring to FIG. 3, according to an embodiment of the present disclosure, a program module 310 (e.g., a program 140 of FIG. 1) may include an operating system (OS) for controlling resources associated with an electronic device (e.g., an electronic device 101 of FIG. 1) and/or various applications (e.g., at least one application program 147 of FIG. 1) which are executed on the OS. The OS may be, for example, Android, iOS, Windows, Symbian, Tizen, or Bada, and the like.

The program module 310 may include a kernel 320, a middleware 330, an application programming interface (API) 360, and/or at least one application 370. At least part of the program module 310 may be preloaded on the electronic device, or may be downloaded from an external electronic device (e.g., a first external electronic device 102, a second external electronic device 104, or a server 106, and the like of FIG. 1).

The kernel 320 (e.g., a kernel 141 of FIG. 1) may include, for example, a system resource manager 321 and/or a device driver 323. The system resource manager 321 may control, assign, or collect, and the like system resources. According to an embodiment of the present disclosure, the system resource manager 321 may include a process management unit, a memory management unit, or a file system management unit, and the like. The device driver 323 may include, for example, a display driver, a camera driver, a BT driver, a shared memory driver, a universal serial bus (USB) driver, a keypad driver, a Wi-Fi driver, an audio driver, or an inter-process communication (IPC) driver.

The middleware 330 (e.g., a middleware 143 of FIG. 1) may provide, for example, functions the application 370 needs in common, and may provide various functions to the application 370 through the API 360 such that the application 370 efficiently uses limited system resources in the electronic device. According to an embodiment of the present disclosure, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, or a payment manager 354.

The runtime library 335 may include, for example, a library module used by a compiler to add a new function through a programming language while the application 370 is executed. The runtime library 335 may perform a function about input and output management, memory management, or an arithmetic function.

The application manager 341 may manage, for example, a life cycle of at least one of the at least one application 370. The window manager 342 may manage graphic user interface (GUI) resources used on a screen of the electronic device. The multimedia manager 343 may ascertain a format necessary for reproducing various media files and may encode or decode a media file using a codec corresponding to the corresponding format. The resource manager 344 may manage source codes of at least one of the at least one application 370, and may manage resources of a memory or a storage space, and the like.

The power manager 345 may act together with, for example, a basic input/output system (BIOS) and the like, may manage a battery or a power source, and may provide power information necessary for an operation of the electronic device. The database manager 346 may generate, search, or change a database to be used in at least one of the at least one application 370. The package manager 347 may manage installation or update of an application distributed by a type of a package file.

The connectivity manager 348 may manage, for example, wireless connection, such as Wi-Fi connection or BT connection, and the like. The notification manager 349 may display or notify events, such as an arrival message, an appointment, and proximity notification, by a method which is not disturbed to the user. The location manager 350 may manage location information of the electronic device. The graphic manager 351 may manage a graphic effect to be provided to the user or a user interface (UI) related to the graphic effect. The security manager 352 may provide all security functions necessary for system security or user authentication, and the like. According to an embodiment of the present disclosure, when the electronic device (e.g., the electronic device 101) has a phone function, the middleware 330 may further include a telephony manager (not shown) for managing a voice or video communication function of the electronic device.

The middleware 330 may include a middleware module which configures combinations of various functions of the above-described components. The middleware 330 may provide a module which specializes according to kinds of OSs to provide a differentiated function. That is, the middleware 330 may dynamically delete some of old components or may add new components.

The API 360 (e.g., an API 145 of FIG. 1) may be, for example, a set of API programming functions, and may be provided with different components according to OSs. For example, in case of Android or iOS, one API set may be provided according to platforms. In case of Tizen, two or more API sets may be provided according to platforms.

The application 370 (e.g., an application program 147 of FIG. 1) may include one or more of, for example, a home application 371, a dialer application 372, a short message service/multimedia message service (SMS/MMS) application 373, an instant message (IM) application 374, a browser application 375, a camera application 376, an alarm application 377, a contact application 378, a voice dial application 379, an e-mail application 380, a calendar application 381, a media player application 382, an album application 383, a clock application 384, a payment application 385, a health care application (e.g., an application for measuring quantity of exercise or blood sugar, and the like), or an environment information application (e.g., an application for providing atmospheric pressure information, humidity information, or temperature information, and the like), and the like.

According to an embodiment of the present disclosure, the application 370 may include an application (hereinafter, for better understanding and ease of description, referred to as “information exchange application”) for exchanging information between the electronic device (e.g., the electronic device 101) and an external electronic device (e.g., the first external electronic device 102 or the second external electronic device 104). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic. That is, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device which communicates with the electronic device, an application which operates in the external electronic device, or a service (e.g., a call service or a message service) provided from the external electronic device.

According to an embodiment of the present disclosure, the application 370 may include an application (e.g., the health care application of a mobile medical device) which is preset according to attributes of the external electronic device. According to an embodiment of the present disclosure, the application 370 may include an application received from the external electronic device (e.g., the first external electronic device 102, the second external electronic device 104, or the server 106). According to an embodiment of the present disclosure, the application 370 may include a preloaded application or a third party application which may be downloaded from a server. Names of the components of the program module 310 according to various embodiments of the present disclosure may differ according to kinds of OSs.

According to various embodiments of the present disclosure, at least part of the program module 310 may be implemented with software, firmware, hardware, or at least two or more combinations thereof. At least part of the program module 310 may be implemented (e.g., executed) by, for example, a processor (e.g., a processor 210 of FIG. 2). At least part of the program module 310 may include, for example, a module, a program, a routine, sets of instructions, or a process, and the like for performing one or more functions.

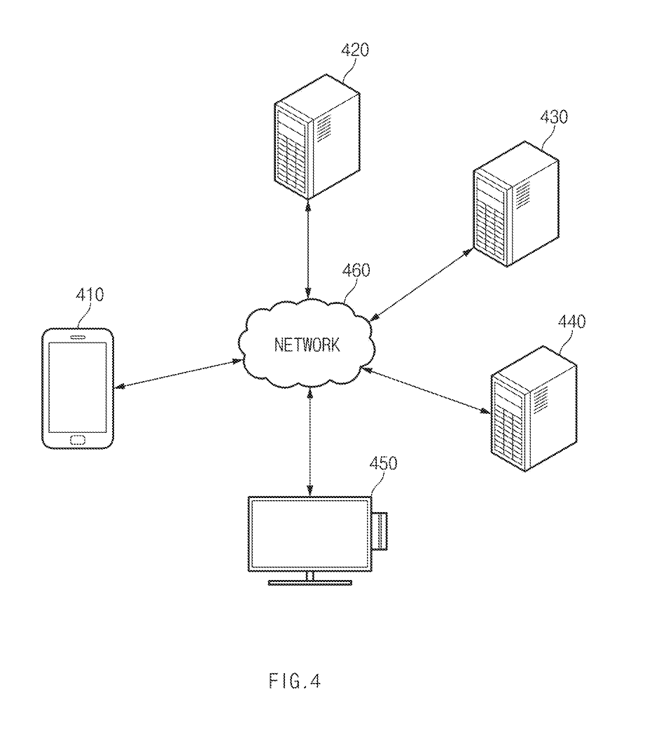

FIG. 4 is a drawing illustrating an environment of performing a secure payment service according to an embodiment of the present disclosure.

Referring to FIG. 4, the environment of performing the secure payment service may include an electronic device 410, a service provider server 420, a card issuer server 430, a mobile network operator (MNO) server 440, and a payment device 450. The secure payment service may be performed through a secure payment application installed in the electronic device 410. A network 460 may connect at least two of the electronic device 410, the service provider server 420, the card issuer server 430, the MNO server 440, and the payment device 450 with each other. Herein, in FIG. 4, an embodiment of the present disclosure is exemplified as the environment for performing the secure payment service. However, embodiments of the present disclosure are not limited thereto.

According to various embodiments of the present disclosure, the electronic device 410 (e.g., a processor 210 of FIG. 2) may perform a registration process for the secure payment service to use the secure payment service. For example, the electronic device 410 may request the service provider server 420 to register a credit card to be used for secure payment. According to various embodiments of the present disclosure, the electronic device 410 may register a debit card, a virtual card, or the like as well as a credit card.

According to various embodiments of the present disclosure, the electronic device 410 (e.g., a communication module 220 of FIG. 2) may transmit information of the credit card to the service provider server 420. The service provider server 420 may transmit the card information received from the electronic device 410 and information of the electronic device 410 to the card issuer server 430. The card issuer server 430 may register the credit card and may generate first security matching information and second security matching information associated with the credit card. The first security matching information and the second security matching information may be used to perform payment through a credit card to be registered later. The card issuer server 430 may transmit the first security matching information and the second security matching information to the service provider server 420. That is, the card issuer server 430 may transmit a file for installing a security information generator corresponding to the second security matching information to the electronic device 410.

According to various embodiments of the present disclosure, the electronic device 410 (e.g., the processor 210) may perform authentication for the electronic device 410 to register the credit card. The authentication may be requested to the service provider server 420 by the electronic device 410 and may be performed through an authentication number which is generated by the MNO server 440 and is then transmitted to the electronic device 410.

Hereinafter, a description will be given of an operation using the secure payment service.

According to various embodiments of the present disclosure, the electronic device 410 (e.g., the processor 210) may select a payment means to be used for payment. The payment means may be at least one credit card registered in the secure payment application. The selection of the payment mans may be performed via a user input received from a user of the electronic device 410.

According to various embodiments of the present disclosure, the electronic device 410 (e.g., the communication module 220) may request the service provider server 420 to transmit first security information or first authentication information (hereinafter referred to as “first security information”) about the selected payment means. The service provider server 420 may request the card issuer server 430 to transmit security information associated with the payment means using the first security matching information and may receive the security information from the card issuer server 430. The first security information may be temporary card information corresponding to the selected payment means.

According to various embodiments of the present disclosure, the electronic device 410 (e.g., the communication module 220) may receive the first security information, and the electronic device 410 (e.g., the processor 210) may generate second security information via the security information generator. The second security information may be security information generated based on time. Similarly, the card issuer server 430 may generate second security information or second authentication information (hereinafter referred to as “second security information”). According to various embodiments of the present disclosure, the second security information may be received from an external device.

According to various embodiments of the present disclosure, the security information may be, for example, a security token.

According to various embodiments of the present disclosure, the electronic device 410 (e.g., the communication module 220) may transmit a payment request including the first security information and the second security information to the payment device 450. The payment device 450 may transmit the payment request to the card issuer server 430. The card issuer server 430 may determine whether the first security information and the second security information are correct or not in the transmitted payment request. For example, the card issuer server 430 may determine whether second security information generated by the electronic device 410 is correct or not by directly generating second security information and comparing the directly generated second security information with the second security information generated by the electronic device 410 (or second security information received from the payment device 450).

According to various embodiments of the present disclosure, the payment device 450 may be a point of sales (POS) device used for an offline payment transaction and may be a value added network (VAN) used for online payment.

According to various embodiments of the present disclosure, the first security information may be used for only online payment, and the second security information may be used for only offline payment.

According to various embodiments of the present disclosure, each of the service provider server 420, the card issuer server 430, and the MNO server 440 may be a single device and may be two or more devices. For example, the card issuer server 430 may include a server which generates first security information and a server which generates second security information, which are independent of each other.

According to various embodiments of the present disclosure, the network 460 may refer to a connection structure which may exchange information between nodes, such as terminals and servers. An embodiment is exemplified as this network 460 includes the Internet, a wireless LAN, a WAN, a personal area network (PAN), third generation (3G), LTE, Wi-Fi, world interoperability for microwave access (WiMAX), wireless gigabit (WiGig), and the like. However, embodiments are not limited thereto.

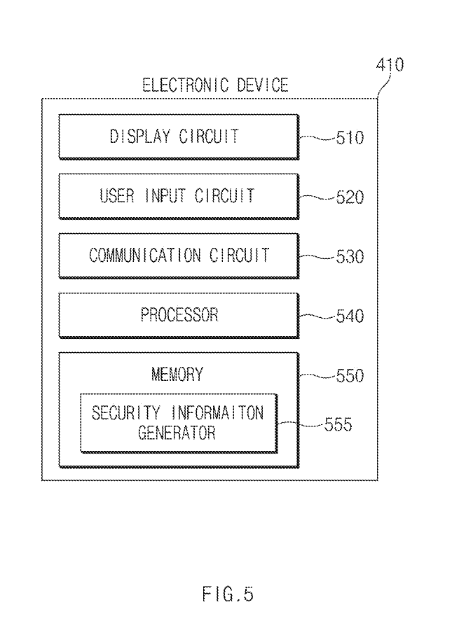

FIG. 5 is a block diagram illustrating a configuration of an electronic device for performing a secure payment service according to an embodiment of the present disclosure.

Referring to FIG. 5, an electronic device 410 may include a display circuit 510, a user input circuit 520, a communication circuit 530, a processor 540, a memory 550, and a security information generator 555. The components of the electronic device 410 shown in FIG. 5 are embodiments of the present disclosure, and various modifications are possible. For example, the electronic device 410 may further include a user interface for receiving any command or information from its user. In this case, in general, the user interface may be an input device, such as a keyboard, a mouse, or the like, or may be a GUI displayed on a screen of the electronic device 410.

According to various embodiments of the present disclosure, the display circuit 510 may display at least one content on the screen of the electronic device 410. The displayed content may include an image, a video, an application icon, an application execution screen, or the like.

The operation of displaying the content at the display circuit 510 may be performed by the processor 540.

The user input circuit 520 may receive a user input received from the user. The user input may include, for example, a touch input or a hover input through a finger or a stylus (e.g., a touch pen) of the user.

The communication circuit 530 may transmit and receive data with the outside (e.g., a service provider server 420, a card issuer server 430, an MNO server 440, a payment device 450, and the like of FIG. 4) over a network (e.g., a network 460 of FIG. 4).

The processor 540 may be implemented with, for example, a SoC and may include one or more of a CPU, a GPU, an image signal processor, an AP, or a CP. The processor 540 may load a command or data received from at least one of other components (e.g., the display circuit 510, the user input circuit 520, or the communication circuit 530) into the memory 550 to process the command or data and may store various data in the memory 550.

The processor 540 may execute a secure payment application and may display an execution screen of the secure payment application on the display circuit 510.

The processor 540 may receive a log-in request (which may include an identifier (ID and a password), entered via the user input circuit 520 and may transmit the log-in request to the service provider server 420 via the communication circuit 530. That is, the processor 540 may receive a result of the log-in request via the communication circuit 530. Hereinafter, a description will be given of a case where the user normally logs in to the electronic device 410.

The processor 540 may request the service provider server 420 to authenticate the electronic device 410, via the communication circuit 530. The processor 540 may receive an authentication number from the MNO server 440 via the communication circuit 530 based on the request. The processor 540 may receive the received authentication number from the user via the user input circuit 520 and may transmit the authentication number to the service provider server 420 via the communication circuit 530.

After the authentication is completed, the electronic device 410 may receive information associated with a payment means, for example, a credit card number, an expiration date, and the like, via the user input circuit 520. The electronic device 410 may transmit a payment means registration request including the information associated with the payment means to the service provider server 420 via the communication circuit 530. The electronic device 410 may receive a response result to the payment means registration request from the card issuer server 430. The response result of the payment means registration request may include a file for installing the security information generator 555.

The processor 540 may install the security information generator 555 in the memory 550 using the received file for installing the security information generator 555.

After registering the payment means, the processor 540 may receive a payment request for specifying the payment means from the user via the user input circuit 520.

The processor 540 may transmit a first security information request to the service provider server 420 via the communication circuit 530. The electronic device 410 may receive first security information from the service provider server 420 via the communication circuit 530. The first security information may be generated as card information for temporary use by the card issuer server 430. According to various embodiments of the present disclosure, the first security information may correspond to the selected payment means.

The processor 540 may generate second security information using the security information generator 555. The second security information may be generated by including valid data or a timestamp of the payment means in at least part of the second security information. The processor 540 may transmit a payment request including the first security information and the second security information to the payment device 540 via the communication circuit 530. That is, the processor 540 may receive a receipt and/or a service as an approval result corresponding to the payment result from the payment device 540 via the communication circuit 530. The payment request may be generated by encrypting at least part of the first security information and the second security information.

If not receiving the first security information since a problem occurs in the service provider server 420 or the card issuer server 430, the processor 540 may use first security information used for an immediately previous transaction rather than the first security information which is not received. Alternatively, the processor 540 may use card information of the selected payment means rather than the first security information which is not received.

If a preset period of time for the first security information elapses or if receiving new first security information, the processor 540 may delete the first security information from the memory 550.

The memory 550 may include an embedded memory or an external memory. The embedded memory may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard disk drive (HDD), or a solid state drive (SSD)).

The external memory may include a flash drive, for example, a compact flash (CF), an SD, a micro-SD, a mini-SD, an xD, an MMC, or a memory stick, and the like. The external memory may operatively and/or physically connect with the electronic device 410 through various interfaces.

Further, the security information generator 555 may be installed in the memory 550. According to various embodiments of the present disclosure, if a condition is met, the security information generator 555 may be updated. A file for the update may be received from the card issuer server 430. That is, the condition may include a time which elapses from a recent update, the number of times of payment after the recent update, or the like.

It may be well understood to those skilled in the art that the display circuit 510, the user input circuit 520, the communication circuit 530, the processor 540, the memory 550, and the security information generator 555 are implemented to be independent of each other or one or more of the display circuit 510, the user input circuit 520, the communication circuit 530, the processor 540, the memory 550, and the security information generator 555 are integrated with each other.

According to various embodiments of the present disclosure, an electronic device may include a communication interface, a memory, and a processor. The processor may be configured to activate an application for payment based on an input on the electronic device, receive first authentication information corresponding to a payment means associated with the payment from an external electronic device via the communication interface, generate second authentication information associated with the payment means using identification information stored in the memory, based on receiving the first authentication information, transmit payment information including at least part of the first authentication information and the second authentication information to the external electronic device via the communication interface, receive a result of authenticating the transmitted payment information from the external electronic device via the communication interface, and perform the payment based on the authenticated result.

According to various embodiments of the present disclosure, the payment means may include a first payment means and a second payment means. The processor may be configured to select one of the first payment means and the second payment means based on another input and request the external electronic device to transmit the first authentication information corresponding to the one payment means.

According to various embodiments of the present disclosure, the processor may be configured to generate the payment information by encrypting the at least part of the first authentication information and the second authentication information as at least part of the transmitting of the payment information.

According to various embodiments of the present disclosure, the processor may be configured to generate the second authentication information by including valid data or a timestamp of the payment means in at least part of the second authentication information as at least part of the transmitting of the payment information.

According to various embodiments of the present disclosure, the first authentication information may include a one-time card (OTC), and the second authentication information may include a token.

According to various embodiments of the present disclosure, the payment means may include card information.

According to various embodiments of the present disclosure, an electronic device may include a communication interface, a memory, and a processor. The processor may be configured to activate an application for payment based on an input on the electronic device, receive first authentication information corresponding to a payment means associated with the payment and second authentication information associated with the payment means from an external electronic device via the communication interface, transmit payment information including at least part of the first authentication information and the second authentication information to the external electronic device via the communication interface, receive a result of authenticating the transmitted payment information from the external electronic device via the communication interface, and perform the payment transaction based on the authenticated result.

According to various embodiments of the present disclosure, the processor may be configured to generate the payment information by encrypting the at least part of the first authentication information and the second authentication information as at least part of the transmitting of the payment information.

According to various embodiments of the present disclosure, an electronic device may include a user input circuit configured to allow a user of the electronic device to select a payment means, a security information generator configured to generate first security information, and a communication circuit configured to receive second security information from the outside and transmit a payment request including the first security information and the second security information to the outside.

According to various embodiments of the present disclosure, the payment request may be for online payment or offline payment.

According to various embodiments of the present disclosure, the first security information may be information generated for each transaction, and the second security information may be card information for temporary use.

According to various embodiments of the present disclosure, the communication circuit may receive the second security information from a service provider server and may transmit the payment request including the first security information and the second security information to a payment device.

According to various embodiments of the present disclosure, the security information generator may be installed by a request received from a card issuer server.

According to various embodiments of the present disclosure, the security information generator may be matched and managed with user information of the electronic device at the card issuer server.

According to various embodiments of the present disclosure, the security information generator may be updated, if a condition is met.

According to various embodiments of the present disclosure, the installing of the security information generator may be performed as a registration result of the payment means.

According to various embodiments of the present disclosure, the payment means may be registered after a terminal is authenticated by a MNO server.

According to various embodiments of the present disclosure, the payment means may include one of at least one card for payment pre-registered in a payment application.

According to various embodiments of the present disclosure, the communication circuit may receive an approval result of the first security information and the second security information from a card issuer server based on the payment request.

According to various embodiments of the present disclosure, the first security information and the second security information may correspond to a payment means selected by the user.

According to various embodiments of the present disclosure, if the second security information is not received, the communication circuit may use security information used for an immediately previous transaction as the second security information.

According to various embodiments of the present disclosure, if the second security information is not received, the communication circuit may use real card information as the second security information.

According to various embodiments of the present disclosure, the electronic device may further include, if a period of time for the second security information elapses or if new second security information is received, a processor configured to delete the second security information.

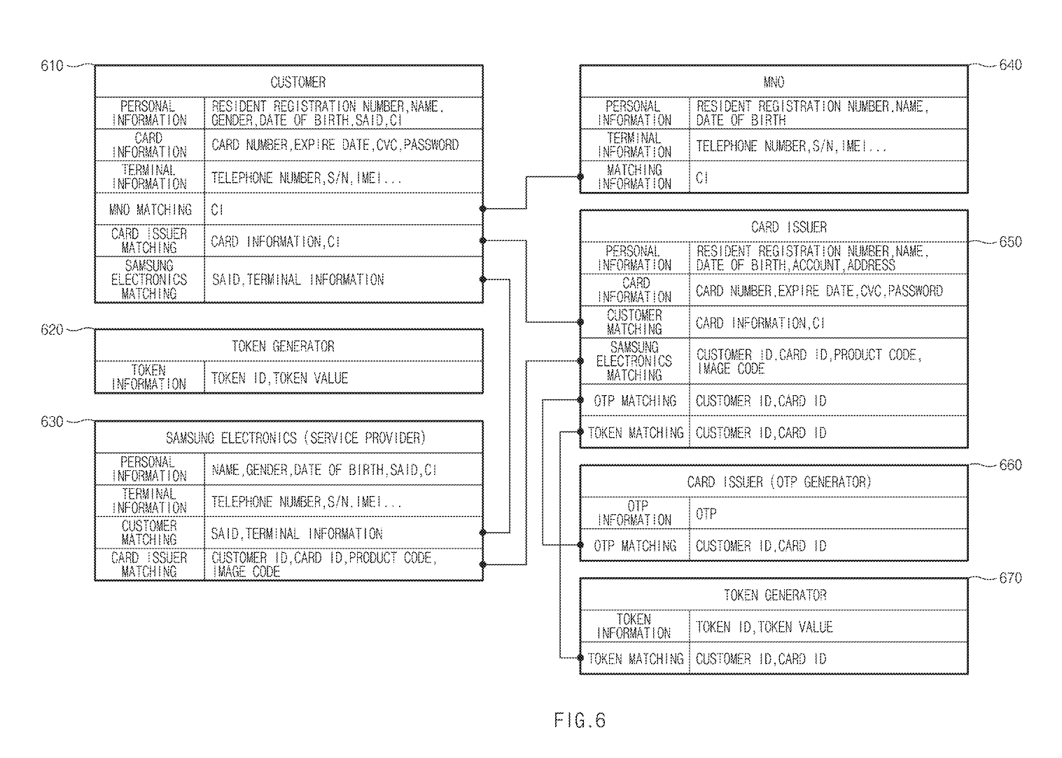

FIG. 6 is a drawing illustrating an information structure according to an embodiment of the present disclosure.

Referring to FIG. 6, information 610 about a customer (e.g., a user of an electronic device 410 of FIG. 4), information 620 about a security information generator, information 630 about a service provider (e.g., Samsung Electronics), information 640 about an MNO, and a plurality of information 650, 660, and 670 about a card issuer are shown.

The information 610 about the customer may include, for example, personal information, card information, information (terminal information) about an electronic device 410 of FIG. 5, MNO matching information, card issuer matching information, and service provider matching information (hereinafter referred to as “Samsung Electronics matching information”).

The MNO matching information may be used when an MNO server 440 of FIG. 4 identifies a customer. The card issuer matching information may be used when a card issuer server 430 of FIG. 4 identifies a customer. The service provider matching information may be used by a service provider server 420 of FIG. 4.

As such, in FIG. 6, a plurality of usable information may be matched by lines.

According to various embodiments of the present disclosure, the electronic device 410 may receive first security information or first authentication information (hereinafter referred to as “first security information”) from the card issuer server 430. The first security information may be included in information 660 about the card issuer (a one-time password (OTP) generator). For example, the card issuer server 430 may identify a customer ID and a card ID of the electronic device 410 which requests the first security information and may obtain first security information corresponding to the customer ID and the card ID from the information 660 about the card issuer (the OTP generator).

The electronic device 410 may receive the first security information and may obtain second security information or second authentication information (hereinafter referred to as “second security information”) from the information 620 about the security information generator. The second security information may be based on at least part of the first security information.

The second security information may be transmitted to the card issuer server 430, included in payment information. The card issuer server 430 may obtain and compare token information matched with the client ID and the card ID of the electronic device 410 from the information 670 about the token generator. Payment transaction may be approved through the comparison operation.

Herein, the plurality of information shown in FIG. 6 may be information according to some of various embodiments of the present disclosure. The configuration of the information shown in FIG. 6 is not limited thereto.

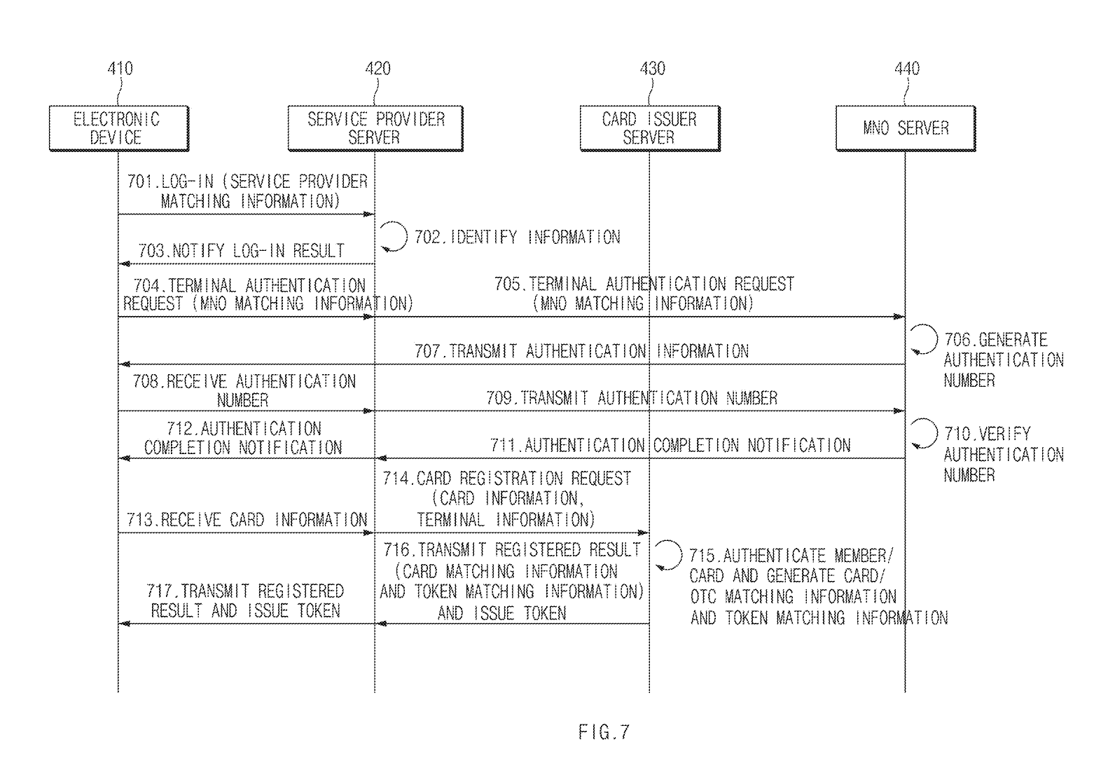

FIG. 7 is a signal sequence diagram illustrating a method for registering a payment means according to an embodiment of the present disclosure.

Referring to FIG. 7, the method for registering the payment means according to various embodiments shown in FIG. 7 may include operations processed in time series by an electronic device 410, a service provider server 420, a card issuer server 430, and an MNO server 440 according to various embodiments shown in FIGS. 1 to 6. Thus, although there are contents omitted below, contents described in connection with the electronic device 410, the service provider server 420, the card issuer server 430, and the MNO server 440 of FIGS. 1 to 6 may be applied to the method for registering the payment means according to various embodiments shown in FIG. 7.

In operation 701, the electronic device 410 may transmit a log-in request to the service provider server 420. In this case, the log-in request may include service provider matching information.

In operation 702, the service provider server 420 may identify information of the electronic device 410 based on the log-in request received in operation 701.

In operation 703, the service provider server 420 may notify the electronic device 410 of a log-in result.

In operation 704, the electronic device 410 may transmit a terminal authentication request to the service provider server 420. The terminal authentication request may include MNO matching information. According to various embodiments of the present disclosure, operation 704 may be performed based on a user input of requesting to register a payment means from the user.

In operation 705, the service provider server 420 may transmit a terminal authentication request to the MNO server 440. The terminal authentication request may include MNO matching information.

In operation 706, the MNO server 440 may generate authentication number.

In operation 707, the MNO server 440 may transmit the authentication number generated in operation 706 to the electronic device 410.

In operation 708, the electronic device 410 may receive an authentication number from the user and may transmit the received authentication number to the service provider server 420.

In operation 709, the service provider server 420 may transmit the authentication number received in operation 708 to the MNO server 440.

In operation 710, the MNO server 440 may determine whether the authentication number received in operation 709 is identical to the authentication number generated in operation 706.

If the authentication number received in operation 709 is identical to the authentication number generated in operation 706, in operation 711, the MNO server 440 may transmit an authentication completion notification to the service provider server 420.

In operation 712, the service provider server 420 may transmit the authentication completion notification received in operation 711 to the electronic device 410.

In operation 713, the electronic device 412 may receive information of a payment means to be registered (e.g., credit card information) and may transmit the received information of the payment means to the service provider server 420.

In operation 714, the service provider server 420 may transmit a payment means registration request including the information of the payment means, transmitted in operation 713, and the information of the electronic device 410 to the card issuer server 430.

In operation 715, the card issuer server 430 may determine whether the user of the electronic device 410 has the payment means transmitted in operation 714. In this case, the card issuer server 430 may generate first security matching information and second security matching information for each payment means.

In operation 716, the card issuer server 430 may transmit the first security matching information and the second security matching information as a result of registering a payment means to the service provider server 420. That is, the card issuer server 430 may transmit a file for installing a security information generator to be transmitted to the electronic device 410 to the service provider server 420. According to various embodiments of the present disclosure, the card issuer server 430 may immediately transmit the file for installing the security information generator to the electronic device 410.

In operation 717, the service provider server 420 may transmit the file for installing the security information generator as the result of registering the payment means to the electronic device 410.

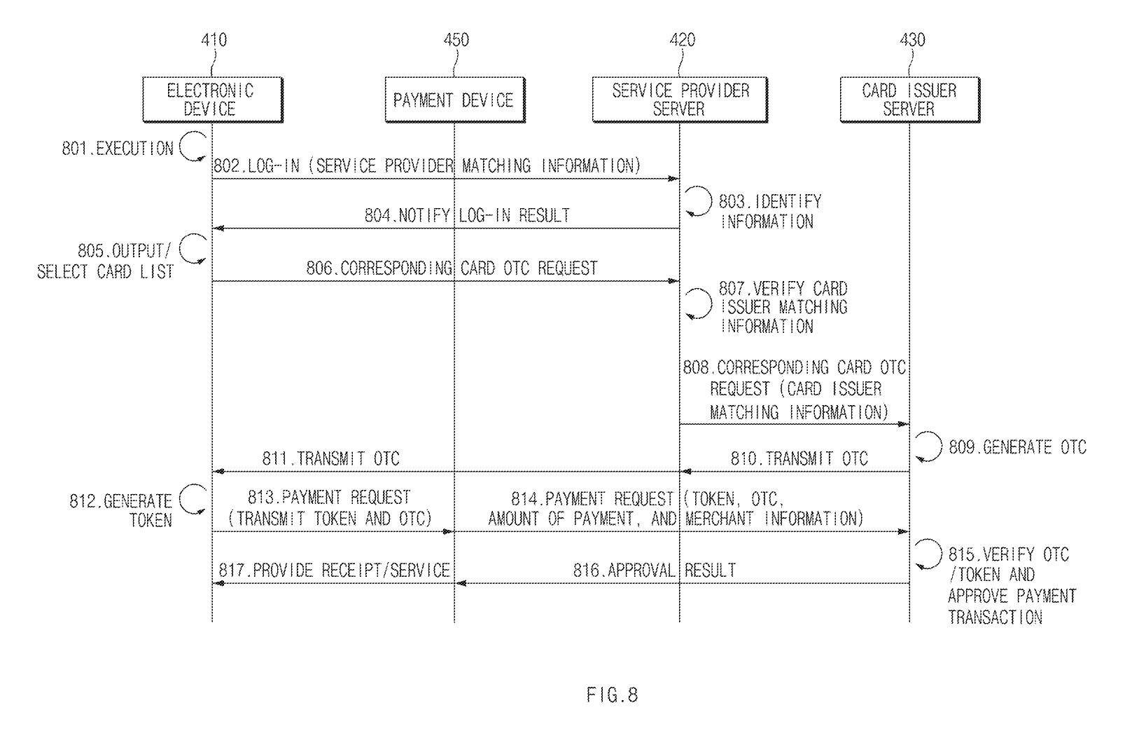

FIG. 8 is a signal sequence diagram illustrating a method for performing payment according to an embodiment of the present disclosure.

Referring to FIG. 8, the method for performing the payment according to various embodiments shown in FIG. 8 may include operations processed in time series by an electronic device 410, a service provider server 420, a card issuer server 430, an MNO server 440, and a payment device 450 according to various embodiments shown in FIGS. 1 to 6. Thus, although there are contents omitted below, contents described in connection with the electronic device 410, the service provider server 420, the card issuer server 430, the MNO server 440, and the payment device 450 of FIGS. 1 to 6 may be applied to the method for performing the payment according to various embodiments shown in FIG. 8.

In operation 801, the electronic device 410 may execute a secure payment application.

In operation 802, the electronic device 410 may transmit a request to log in to the secure payment application to the service provider server 420. In this case, the log-in request may include service provider matching information.

In operation 803, the service provider server 420 may identify information of the electronic device 410 based on the log-in request received in operation 802.

In operation 804, the service provider server 420 may notify the electronic device 410 of a log-in result.

After logging in to the secure payment application, in operation 805, the electronic device 410 may display at least one or more payment means on a screen of the electronic device 410 and may receive a user input for selecting one of the at least one or more payment means.

In operation 806, the electronic device 410 may request the service provider server 420 to transmit first security information corresponding to the payment means selected in operation 805.

In operation 807, the service provider server 420 may verify information about the payment means selected in operation 805 through card issuer matching information.

In operation 808, the service provider server 420 may transmit a first security information request for the payment means to the card issuer server 430. The first security information request may include card issuer matching information.

In operation 809, the card issuer server 430 may generate first security information corresponding to the payment means.

In operation 810, the card issuer server 430 may transmit the first security information generated in operation 809 to the service provider server 420.

In operation 811, the service provider server 420 may transmit the first security information transmitted in operation 810 to the electronic device 410.

In operation 812, the electronic device 410 may generate second security information using a security information generator.

In operation 813, the electronic device 410 may transmit a payment request including the first security information transmitted in operation 811 and the second security information generated in operation 812 to the payment device 450.

In operation 814, the payment device 450 may transmit a payment request including the first security information and the second security information transmitted in operation 813, amount of payment the user of the electronic device 410 will pay, and merchant information to the card issuer server 430.

In operation 815, the card issuer server 430 may verify the first security information and the second security information transmitted in operation 814 and may approve payment transaction. The card issuer server 430 according to various embodiments of the present disclosure may directly generate second security information and may compare the generated second security information with the second security information transmitted in operation 814.

In operation 816, the card issuer server 430 may notify the payment device of the approval result.

In operation 817, the payment device 450 may provide a receipt and a service according to the approval result.

In FIG. 8, an embodiment is exemplified as an order of the above-mentioned operations (operations 801 to 817). However, embodiments are not limited thereto. In other words, an order among the above-mentioned operations may be changed to each other, and some of the above-mentioned operations may be simultaneously executed. That is, the above-mentioned operations may be periodically repeated at intervals of a time and may be performed again based on a user input.

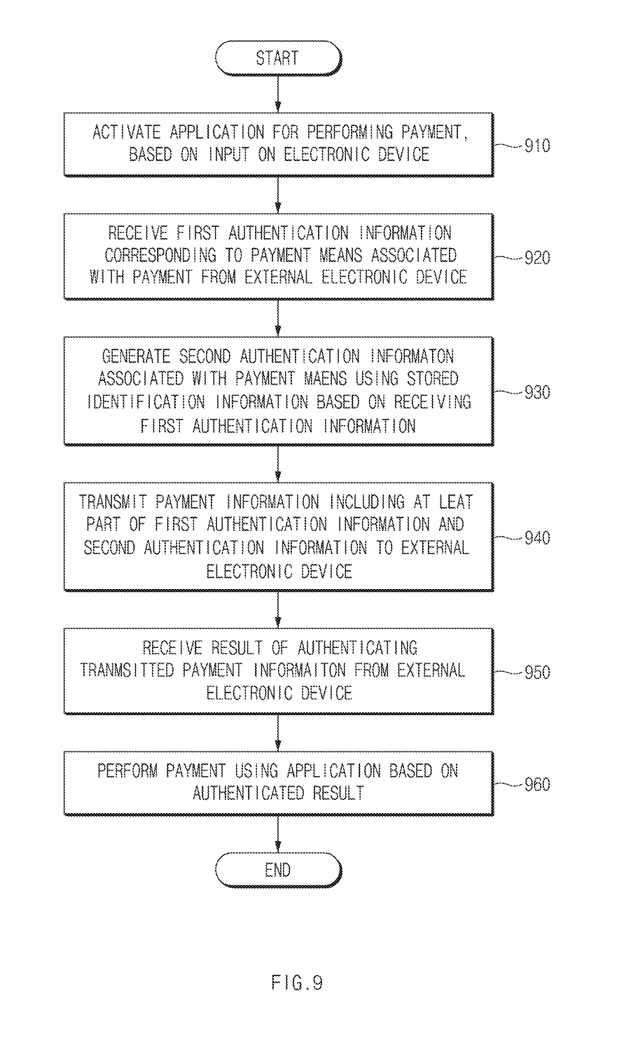

FIG. 9 is a flowchart illustrating a method for performing payment in an electronic device according to an embodiment of the present disclosure.

Referring to FIG. 9, the method for performing the payment according to various embodiments shown in FIG. 9 may include operations processed in time series by an electronic device 410, a service provider server 420, a card issuer server 430, an MNO server 440, and a payment device 450 according to various embodiments shown in FIGS. 1 to 8. Thus, although there are contents omitted below, contents described in connection with the electronic device 410, the service provider server 420, the card issuer server 430, the MNO server 440, and the payment device 450 of FIGS. 1 to 8 may be applied to the method for performing the payment according to various embodiments shown in FIG. 9.

In operation 910, the electronic device 410 may activate an application for performing payment, based on an input on the electronic device 410. The input may be a touch input and the like received from a user of the electronic device 410.

In operation 920, the electronic device 410 may receive first authentication information corresponding to a payment means associated with the payment from an external electronic device. The payment means may be, for example, a credit card. That is, the first authentication information may be card information for temporary use.

In operation 930, the electronic device 410 may generate second authentication information associated with the payment means using identification information stored in a memory of the electronic device 410, based on receiving the first authentication information in operation 920. The second authentication information may be token information generated by a token generator stored in the memory. The second authentication information may be information different for each transaction.

In operation 940, the electronic device 410 may generate payment information including at least part of the first authentication information and the second authentication information and may transmit the generated payment information to the external electronic device.

In operation 950, the electronic device 410 may receive a result of authenticating the transmitted payment information from the external electronic device.

In operation 960, the electronic device 410 may perform the payment using the application activated in operation 910, based on the result authenticated in operation 950.

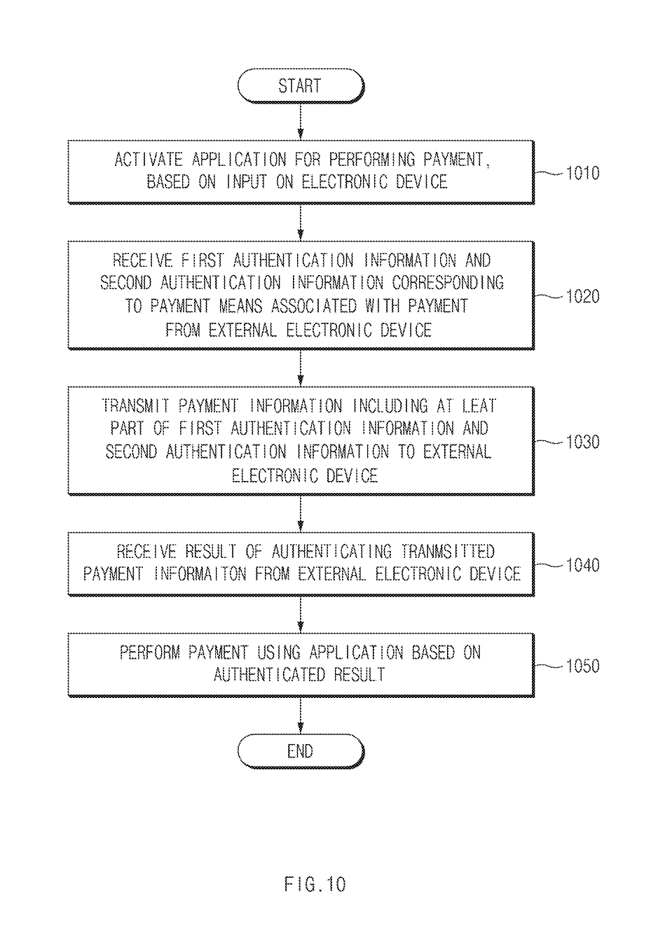

FIG. 10 is a flowchart illustrating a method for performing payment in an electronic device according to an embodiment of the present disclosure.

Referring to FIG. 10, the method for performing the payment according to various embodiments shown in FIG. 10 may include operations processed in time series by an electronic device 410, a service provider server 420, a card issuer server 430, an MNO server 440, and a payment device 450 according to various embodiments shown in FIGS. 1 to 8. Thus, although there are contents omitted below, contents described in connection with the electronic device 410, the service provider server 420, the card issuer server 430, the MNO server 440, and the payment device 450 of FIGS. 1 to 8 may be applied to the method for performing the payment according to various embodiments shown in FIG. 10.

In operation 1010, the electronic device 410 may activate an application for performing payment, based on an input on the electronic device 410.

In operation 1020, the electronic device 410 may receive first authentication information and second authentication information corresponding to a payment means associated with the payment from an external electronic device. The first authentication information and the second authentication information may be received from the same external electronic device or may be received from different external electronic devices.

In operation 1030, the electronic device 410 may transmit payment information including at least part of the first authentication information and the second authentication information to the external electronic device.

In operation 1040, the electronic device 410 may receive a result of authenticating the payment information transmitted in operation 1030 from the external electronic device.

In operation 1050, the electronic device 410 may perform the payment using the application activated in operation 1010, based on the authenticated result in operation 1040.

According to various embodiments of the present disclosure, a method performed in an electronic device may include allowing a user of the electronic device to select a payment means, receiving first security information from the outside, generating second security information, and transmitting a payment request including the first security information and the second security information to the outside.

According to various embodiments of the present disclosure, the payment request may be for online payment or offline payment.

According to various embodiments of the present disclosure, the first security information may be card information for temporary use.

According to various embodiments of the present disclosure, the payment means may be one of at least one card for payment pre-registered in a payment application.

According to various embodiments of the present disclosure, the first security information may correspond to the selected payment means.

According to various embodiments of the present disclosure, when the first security information is not received, security information used for an immediately previous transaction may be used as the first security information.

According to various embodiments of the present disclosure, the method further include, if a period of time for the first security information elapses or if new first security is received, deleting the first security information.

According to various embodiments of the present disclosure, a method performed in an electronic device may include activating an application for performing payment based on an input on the electronic device, receiving first authentication information corresponding to a payment means associated with the payment from an external electronic device via a communication interface of the electronic device, generating second authentication information associated with the payment means using identification information stored in a memory of the electronic device, based on receiving the first authentication information, transmitting payment information including at least part of the first authentication information and the second authentication information to the external electronic device via the communication interface, receiving a result of authenticating the transmitted payment information from the external electronic device via the communication interface, and performing the payment using the application based on the authenticated result.

According to various embodiments of the present disclosure, a method performed in an electronic device may include activating an application for performing payment based on an input on the electronic device, receiving first authentication information corresponding to a payment means associated with the payment and second authentication information associated with the payment means from an external electronic device via a communication interface of the electronic device, transmitting payment information including at least part of the first authentication information and the second authentication information to the external electronic device via the communication interface, receiving a result of authenticating the transmitted payment information from the external electronic device via the communication interface, and performing the payment using the application based on the authenticated result.

The terminology “module” used herein may mean, for example, a unit including one of hardware, software, and firmware or two or more combinations thereof. The terminology “module” may be interchangeably used with, for example, terminologies “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

According to various embodiments of the present disclosure, at least part of a device (e.g., modules or the functions) or a method (e.g., operations) may be implemented with, for example, instructions stored in computer-readable storage media which have a program module. When the instructions are executed by a processor (e.g., a processor 120 of FIG. 1), one or more processors may perform functions corresponding to the instructions. The computer-readable storage media may be, for example, a memory 130 of FIG. 1.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

According to various embodiments of the present disclosure, a storage media may store instructions. The instructions may be configured to, when executed by at least one processor, cause the at least one processor to perform at least one operation. The at least one operation may include activating an application for performing payment based on an input on an electronic device, receiving first authentication information corresponding to a payment means associated with the payment from an external electronic device via a communication interface of the electronic device, generating second authentication information associated with the payment means using identification information stored in a memory of the electronic device, based on receiving the first authentication information, transmitting payment information including at least part of the first authentication information and the second authentication information to the external electronic device via the communication interface, receiving a result of authenticating the transmitted payment information from the external electronic device via the communication interface, and performing the payment using the application based on the authenticated result.

According to various embodiments of the present disclosure, a storage media may store instructions. The instructions may be configured to, when executed by at least one processor, cause the at least one processor to perform at least one operation. The at least one operation may include activating an application for performing payment based on an input on an electronic device, receiving first authentication information corresponding to a payment means associated with the payment and second authentication information associated with the payment method from an external electronic device via a communication interface of the electronic device, transmitting payment information including at least part of the first authentication information and the second authentication information to the external electronic device via the communication interface, receiving a result of authenticating the transmitted payment information from the external electronic device via the communication interface, and performing the payment using the application based on the authenticated result.

Modules or program modules according to various embodiments may include at least one or more of the above-mentioned components, some of the above-mentioned components may be omitted, or other additional components may be further included. Operations executed by modules, program modules, or other components may be executed by a successive method, a parallel method, a repeated method, or a heuristic method. That is, some operations may be executed in a different order or may be omitted, and other operations may be added.

According to various embodiments of the present disclosure, the electronic device may provide a payment request including security information received from the outside.

While the present disclosure has been shown and described with reference to various embodiments thereof, it will be understood by those skilled the art that various changes in form and details may be made therein without departing from the spirit and scope of the present disclosure as defined by the appended claims and their equivalents.

What is claimed is:

1. An electronic device comprising:
a communication interface;
a memory; and
a processor,
wherein the processor is configured to:
activate an application for a payment transaction based on an input on the electronic device,
receive first authentication information corresponding to a payment means associated with the payment transaction from an external electronic device via the communication interface,
generate second authentication information associated with the payment means using identification information stored in the memory, based on receiving the first authentication information,
transmit payment information comprising at least part of the first authentication information and the second authentication information to the external electronic device via the communication interface,
receive a result of authenticating the transmitted payment information from the external electronic device via the communication interface, and
perform the payment transaction based on the authenticated result.

2. The electronic device of claim 1,
wherein the payment means comprises a first payment means and a second payment means, and
wherein the processor is configured to:
select one of the first payment means and the second payment means based on another input, and
request the external electronic device to transmit the first authentication information corresponding to the one payment means.

3. The electronic device of claim 1, wherein the transmitting of the payment information at the processor comprises:
generating the payment information by encrypting the at least part of the first authentication information and the second authentication information.

4. The electronic device of claim 1, wherein the transmitting of the payment information at the processor comprises:
generating the second authentication information by including valid data or a timestamp of the payment means in at least part of the second authentication information.

5. The electronic device of claim 1,
wherein the first authentication information comprises a one-time card (OTC), and
wherein the second authentication information comprises a token.

6. An electronic device comprising:
a communication interface;
a memory; and
a processor,
wherein the processor is configured to:
activate an application for a payment transaction based on an input on the electronic device;
receive first authentication information corresponding to a payment means associated with the payment transaction and second authentication information associated with the payment means from an external electronic device via the communication interface, the second authentication information being generated using identification information stored in the memory;
transmit payment information comprising at least part of the first authentication information and the second authentication information to the external electronic device via the communication interface;
receive a result of authenticating the transmitted payment information from the external electronic device via the communication interface; and
perform the payment transaction based on the authenticated result.

7. The electronic device of claim 6, wherein the transmitting of the payment information at the processor comprises:
generating the payment information by encrypting the at least part of the first authentication information and the second authentication information.

8. An electronic device comprising:
a user input circuit configured to allow a user of the electronic device to select a payment means;
a security information generator configured to generate first security information; and
a communication circuit configured to:
receive second security information from the outside, and
transmit a payment request comprising the first security information and the second security information to the outside.

9. The electronic device of claim 8,
wherein the first security information is information generated for each transaction, and
wherein the second security information is card information for temporary use.

10. The electronic device of claim 8, wherein the communication circuit is further configured to:
receive the second security information from a service provider server, and
transmit the payment request comprising the first security information and the second security information to a payment device.

11. The electronic device of claim 8, wherein the security information generator is installed by a request received from a card issuer server.

12. The electronic device of claim 11, wherein the security information generator is matched and managed with user information of the electronic device at the card issuer server.

13. The electronic device of claim 11, wherein the installing of the security information generator is performed as a registration result of the payment means.

14. The electronic device of claim 13, wherein the payment means is registered after a terminal is authenticated by a mobile network operator (MNO) server.

15. The electronic device of claim 8, wherein the payment means comprises one of at least one card for payment pre-registered in a payment application.

16. The electronic device of claim 8, wherein the communication circuit is further configured to receive an approval result of the first security information and the second security information from a card issuer server based on the payment request.

17. The electronic device of claim 8, wherein the first security information and the second security information correspond to a payment means selected by the user.

18. The electronic device of claim 8, wherein, if the second security information is not received, the communication circuit is further configured to use security information used for an immediately previous transaction as the second security information.

19. The electronic device of claim 8, wherein, if the second security information is not received, the communication circuit is further configured to use real card information as the second security information.

20. The electronic device of claim 8, wherein, if a period of time for the second security information elapses or if newly generated second security information is received, the second security information is deleted.
